(19) United States
(12) Patent Application Publication
(10) Pub. No.: US 2007/0268590 A1
(43) Pub. Date: Nov. 22, 2007

(54) Lenticule and Prism Unit

(75) Inventor: Armin Schwerdtner, Dresden (DE)

Correspondence Address: SYNNESTVEDT LECHNER & WOODBRIDGE LLP, P O BOX 592, 112 NASSAU STREET, PRINCETON, NJ, 08542-0592, US

(73) Assignee: SEEREAL TECHNOLOGIES GMBH, Dresden (DE)

(21) Appl. No.: 11/573,847

(22) PCT Filed: Apr. 25, 2005
(86) PCT No.: PCT/EP05/04391

§ 371 Date: May 22, 2007

(30) Foreign Application Priority Data
Aug. 19, 2004 (DE) 10 2004 040 213.2

(51) Int. Cl. G02B 27/10

(52) U.S. Cl. 359/619

(57) ABSTRACT

This invention relates to a lenticule-prism-unit and to an illumination device for an autostereoscopic display. The display comprises (seen in the direction of light propagation) an illumination matrix (7), a projection matrix (8) and a transmissive image matrix (5). The illumination matrix consists of a multitude of controllable illumination elements (21). The projection matrix (8) focuses the light of these illumination elements (21) such that the image matrix (5) and a preferred visibility region (6) are illuminated in a directed manner. According to this invention, the projection matrix (8) comprises a lenticular array (LM) and a prism mask (PM) with wedge elements (K1, K2, . . . ) and coplanar elements (P1, P2, . . . ).

The elements (K1, K2, . . . , P1, P2, . . . ) are arranged such that a multiple number of projections of the light of an illumination element (21) are projected into the visibility region (6), thus generating a broadened resultant luminance distribution (V) stretching from (A) to (C′). The resultant projections of laterally adjacent illumination elements are overlapped at their margins, thus creating a near-homogeneous luminance distribution (V). The image quality increases considerably thanks to the homogeneous brightness thus achieved.

### FIELD OF THE INVENTION

The present invention relates to a lenticule-prism-unit, in particular for autostereoscopic displays. A basic lenticule-prism-unit contains a lenticular-array composed of a multitude of parallel lenticules. This invention further relates to an illumination device for autostereoscopic displays with a transmissive image matrix for representing two- and three-dimensional information with a high image quality.

In this document the term “autostereoscopic displays” denotes displays used by at least one viewer to view from a freely selectable position 3D contents on the information panel without any auxiliary means.

Seen in the direction of light propagation, the illumination device comprises an illumination matrix, containing a multitude of illumination elements arranged in a regular pattern, and a projection matrix with optical projection elements.

In autostereoscopic displays the light of the illumination unit passes through the following image matrix. In the image matrix, the light for left sweet-spots is modulated with left images and the light for right sweet-spots is modulated with right images. The light is then focused on the respective eyes of the viewer(s). During this process, the light for one eye must not cross-talk to the other eye. Further, there must be no disturbance in image homogeneity if the display is viewed from the sweet-spots, i.e. the regions of stereoscopic cross-talk-free viewing.

A major field of application of this invention are displays, where individual information can be presented to several viewers, such as in a vehicle where the vehicle driver is presented route-related information while the passenger watches a movie.

### PRIOR ART

The projection matrix of an autostereoscopic display is usually realised in the form of a lenticular array composed of simple spherical lenticules; this is frequently mentioned in the literature and in other inventions. Further, a variety of designs of lenticules used in lenticular arrays, including a combination of lenticules and prism elements, is known

DE 297 10 551 U1 describes an autostereoscopic arrangement for three-dimensional representation of information using a colour display. In front of the colour display a prism mask is provided and is provided with one prismatic wedge per image column, where each prism wedge is equivalent to the width of the image column, and the angle is chosen such that the left columns of the display are seen by the left eye and the right columns are seen by the right eye.

U.S. Pat. No. 3,740,119 A describes a projection device which, aiming at multiplying the projections and precise focusing, contains lenticular sheets, wherein the known spherical or cylindrical shape of the lenticules is approximated by axially-symmetrical polygonal shapes. Adjacent prism faces cause a number of projections displaced by a certain distance (depending on the prism angle), whereby equidistant projections are generated thanks to equidistant prism angles.

In the following, prior art illumination devices for an autostereoscopic display with a transmissive image matrix will be considered. The projection matrix usually contains a lenticular array with spherical lenticules. Great demands are made on the projection matrix, because this matrix most significantly affects the properties of the projection in the viewing plane. The image quality, as judged by the viewer and, for example, the distribution of brightness is mainly attributed to this matrix. The distribution of brightness across the image depends e.g. on whether and how the discrete light sources represented by the illumination elements of the illumination matrix cause a uniform brightness in the viewing plane.

A fundamental autostereoscopic display is described by the applicant in EP 0 691 000 B1. The display contains an optical system for two- and three-dimensional representation of information including a transmissive matrix, said optical system generating images assigned to every single viewer, and at least one point light source or line light source, a collimating optical system and a focusing optical system. Each pixel of the transmissive matrix is matched with a prism of a prism mask and with a phase element of a phase mask, whereby the light corresponding to the individual images is deflected and focused on the respective eyes of the viewer(s).

DE 103 59 403 A1 filed by the applicant describes an autostereoscopic multi-user display with a sweet-spot unit. The display comprises an illumination matrix and a projection matrix with a field lens. The projection matrix projects through elements of the illumination matrix to the space in front of the display in adequate directions, and the following field lens focuses them on the eyes of the viewer(s), thus forming sweet-spots. The projection matrix comprises two parallel single lenticular arrays with identical orientation. In another embodiment of that invention, the projection matrix comprises a double lenticular array.

Another autostereoscopic display is disclosed in EP 0827350 A3. It consists of a light source for illumination, a planar illuminant, a carrier mask with a chessboard-like arrangement of openings, and further vertical cylindrical lenses array (semi cylinders) and a transmissive image matrix. The lens array functions to direct the light of the openings through the transmissive image matrix.

Another autostereoscopic display is described in EP0881844 B4; the projection matrix comprises a first lenticular array with horizontal semi-cylinder lenticules, a diffuser, and another lenticular mask with horizontal semi-cylinder lenticules.

Another optical system is disclosed in EP1045596 A2; the matrix consists of an array of vertical cylindrical lenses and a following array of horizontal cylindrical lenses (seen in the direction of light propagation). The lenses of the lens arrays are disposed at distances corresponding with the pattern of the shutter openings.

An essential requirement of the illumination device, and, particularly, of the projection matrix, is that the image matrix and the preferred region of visibility are illuminated as homogeneously as possible in the viewing plane; in the above mentioned documents this homogeneous illumination is not realized in a desirable manner.

The alignment of the bundles of rays of individual lenticules to form consistently illuminated regions in the viewing or projection plane is not explained in detail in those documents, although this is crucial for the quality of the visible image within the projection.

The bundles of rays are not adequately aligned, considering there are separate, discrete light sources and regions with only little light passing through. In particular, the images of interstices produce transitions with low luminance in the preferred region of visibility. These transitional areas are perceivable by the viewer as unwanted narrow dark lines—zones of low luminance. This results in a recognizably worse image quality.

In order to ensure that all points of the image matrix can be seen with the required homogeneous brightness in the preferred region of visibility, it is necessary to superimpose the bundles of rays generated by the illumination elements in the region of visibility. This superimposition is not reached or cannot be reached adequately by the above-mentioned solutions when using cylindrical, semi-cylindrical or spherical lenticules.

An aspherical lenticule or even an asymmetric aspherical lenticule is required to achieve an overlapping of rays. However, aspherical and/or asymmetric lenticules have the disadvantage that they are very difficult to manufacture and costly, particularly when seen from the miniaturization point of view. In the context of progressing miniaturization of the lenticules the danger arises that the limits of cost-efficient and reliable production of lenticular arrays will be reached and exceeded.

While keeping the above-mentioned requirements in mind, the object of this invention is to provide a projection element which features the advantageous optical properties of an aspherical and/or asymmetric lenticule, can be manufactured and aligned simply, and which can be produced inexpensively and reliably, also taking into account aspects of progressing miniaturization.

### SUMMARY OF THE INVENTION

A basic lenticule-prism-unit in particular as used in autostereoscopic displays contains a lenticular array composed of a multitude of adjacent parallel lenticules in the form of cylindrical lenses. The lenticular array is combined with a prism mask. This mask contains a multitude of prism mask elements composed of wedge elements. Several prism mask elements are assigned to each lenticule. In a preferred embodiment, wedge elements and one or more coplanar elements are assigned to a lenticule.

The invention is based on the idea that an aspherical and/or an asymmetric lenticule is discretely approximated by combining a spherical lenticule and the assigned prism mask elements.

In a first, simple discrete approximation of an aspherical lenticule, a lenticule is combined with one coplanar element disposed in the centre of the optical axis of the lenticule, and with two mirror-symmetrical wedge elements. A larger number of prism mask elements can be used to enhance the discrete approximation of asymmetric and/or aspherical lenticules in a simple way.

According to a preferred embodiment, the prism mask is placed in front of the lenticular array (seen in the direction of light propagation), which reduces spherical aberrations and results in a high-quality optical projection. Lenticular array and prism mask may be attached to the same substrate. According to another embodiment, the prism mask is disposed behind the lenticular array with its plane face on the side of light exit. Thus, lenticules and wedge elements face each other. Lenticular array and prism mask may be tangent at one or several points of the lenticule curvature, so that they form a compound body.

Another aspect of this invention relates to an illumination device in particular for an autostereoscopic display with a transmissive image matrix. The illumination device comprises an illumination matrix and a projection matrix arranged in this order, seen in the direction of light propagation. The illumination matrix consists of a multitude of illumination elements arranged in a regular pattern. According to a simple embodiment, the illumination matrix consists of a backlight as a light source and a shutter with controllable openings for the control of the light passage. Between the individual illumination elements or shutter openings there are regions with low transmittance, e.g. caused by conductor paths. The following projection matrix contains a lenticular array with a multitude of lenticules in the form of cylindrical lenses. The lenticules are preferably aligned with the columns or lines of illumination elements. The projection matrix focuses the light passing through the illumination elements so that the image matrix and a selectable preferred visibility region in the viewing plane are illuminated in a directed manner.

The lenticule-prism-unit is part of the projection matrix. According to the invention, the prism mask elements are chosen and arranged such that in the visibility region the projections of the illumination elements are multiplied by the number of prism mask elements. Further, the prism mask elements are arranged such that these multiple projections superimpose so that an almost homogeneous luminance distribution is created on the image matrix and in the visibility region.

With the arrangement according to the invention, multiple projections (corresponding to the number of prism mask elements) of an illumination element are generated in the preferred visibility region. These projections are identified by their corresponding trapezoid-shaped luminance distributions. These luminance distributions are staggered in an overlapping manner so as to cause a broadened area of homogeneous luminance due to these overlapping luminance trapezoids.

The resultant luminance area of an illumination element is thus substantially broadened, consequentially the projections of several illumination elements assigned with a lenticule overlap. Laterally adjacent illumination elements generate the mentioned broadened trapezoid-shaped luminance distributions in the visibility region. With the arrangement according to this invention, they overlap at their margins.

The mentioned trapezoidal distributions are composed of a rectangle of the ideal distribution of the bundle of rays and by tapered margins, which are caused by the real optical properties of the lenticule and the prism mask elements. With the arrangement and alignment according to this invention, above-mentioned margins of the individual luminance distributions overlap in the visibility region. Consequently, when following the idea of this invention, the arrangement of lenticules and prism mask elements and in particular the orientation of the wedge elements is determined by this required overlapping of luminance distributions—per illumination element and laterally adjacent elements—and a fixed geometry of these illumination elements.

The overlapping of these margins of the projections of the illumination elements generates a near-homogeneous resultant luminance distribution in these transitional regions. Thus, the illumination in the visibility region and on the image matrix is near-homogeneous. Darker regions between the projections of the illumination elements are almost completely eliminated, so that the image quality as perceived by the viewer is considerably improved.

With a further division of the prism mask in terms of approximating an aspheric lenticule the resulting luminance distribution is substantially improved. This approximation applies likewise to an asymmetric lenticule. It may become necessary to do without coplanar elements.

The lenticule-prism-unit according to the invention can also preferably be used for known designs of double lenticular arrays with vertices in the same or in opposite directions and is also usable in crossed lenticular arrays. The lenticule-prism-unit may be combined with further optical elements, for example with a field lens.

### SHORT DESCRIPTION OF FIGURES

The following Figures illustrate embodiments of the lenticule-prism-unit and illumination device according to this invention, both being part of an autostereoscopic display.

FIG. 1 shows a detail of the illumination device with lenticule-prism-unit according to this invention and, schematically, the distribution of the bundles of rays for one illumination element.

FIG. 2 shows an illumination device and the distribution of the bundles of rays similar to FIG. 1, but for three adjacent illumination elements.

FIG. 3a shows a detail of a compound unit, representing a preferred form of the combination of the lenticular array and prism mask.

FIG. 3b and FIG. 4 show other embodiments of the combination of the lenticular array and prism mask.

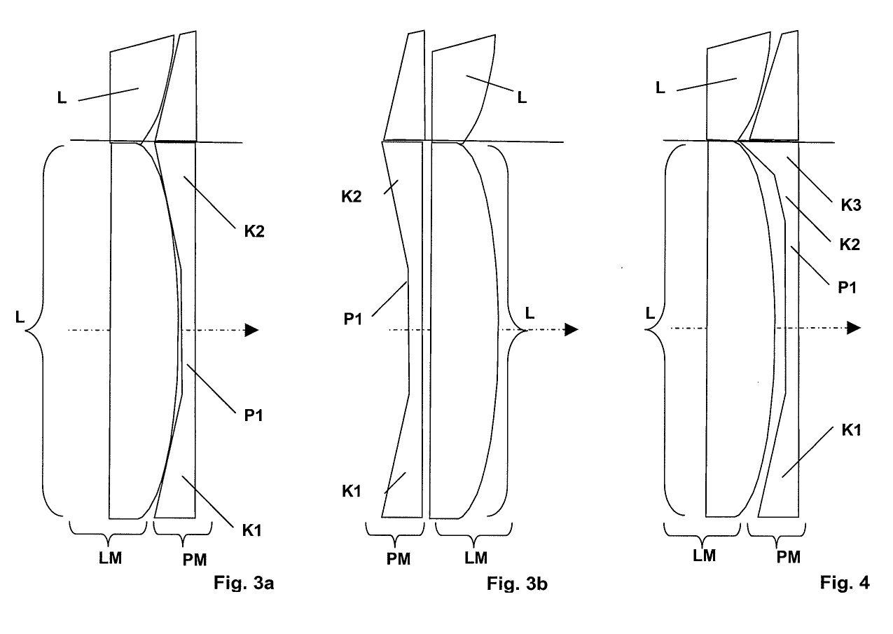

The details of the lenticule-prism-unit shown in FIGS. 3a, 3b and 4 as well as the assignment of prism mask elements are all related to one lenticule. The direction of light propagation is indicated in these Figures by an arrow.

The lenticule-prism-unit according to this invention will be explained below with respect to an autostereoscopic display. Seen in the direction of light propagation, the display contains in a first section an illumination matrix 7 composed of a multitude of controllable illumination elements through which the light passes. In this example, the illumination matrix 7 is not emitting light itself, but comprises a backlight 1 as a light source and a shutter 2 containing a multitude of openings 21 arranged in a matrix for controlled light passage. It is followed by a projection matrix 8, which comprises a lenticular array LM composed of a multitude of individual lenticules L. In this embodiment, the lenticules are arranged parallel with the columns or lines of the openings 21 of the shutter 2. The projection matrix 8 focuses the light passing through the openings 21 so that the subsequent transmissive image matrix 5 and a selectable preferred visibility region 6 in the viewing plane 9 are illuminated in a directed manner.

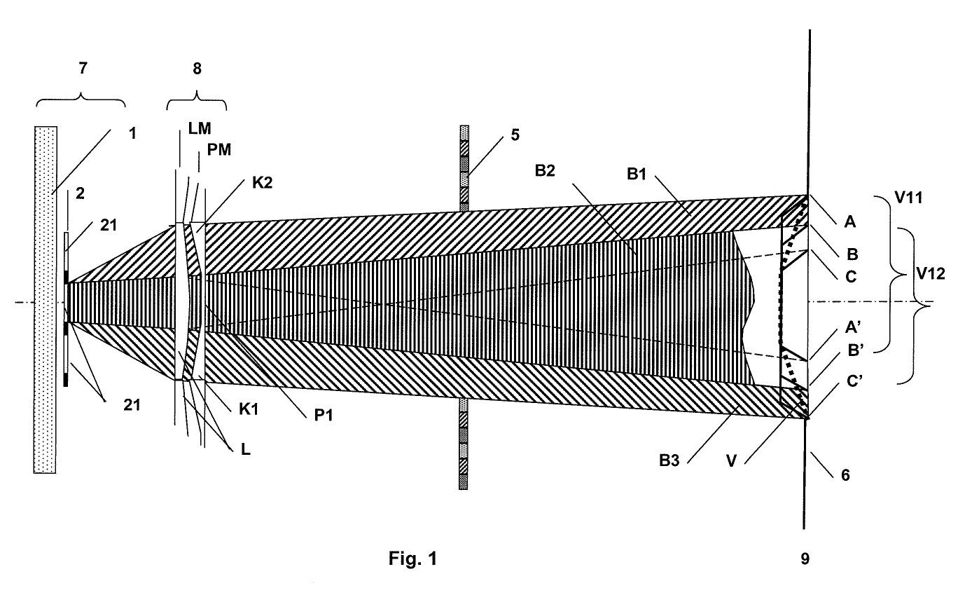

FIG. 1 shows a detail of the illumination device with lenticule-prism-unit according to the invention and, schematically, the distribution of the bundles of rays for one opening 21 of the shutter 2. The projection matrix 8 is a combination of a lenticular array LM and a prism mask PM. The prism mask PM is disposed behind the lenticular array LM, seen in the direction of light propagation. The prism mask PM contains a multitude of wedge elements and coplanar elements, whereby several prism mask elements K1, K2, . . . , P1, P2, . . . are assigned to each lenticule L.

In this schematic embodiment the lenticule-prism-unit realises a simple discrete approximation of an aspheric lenticule. FIG. 3 shows further details of the lenticule-prism-unit.

In this embodiment, a coplanar element P1 disposed in the centre of the optical axis of the lenticule L and two mirror-symmetrically arranged wedge elements K1, K2 of like angular design are assigned to a lenticule L. The wedge elements K1, K2 are disposed towards the edge of the lenticules. The prism mask elements K1, K2, P1 divide the aperture of the lenticule L into three intervals of same width. The wedge elements K1, K2 face the lenticule L. The lenticular array LM is planar on its side of light entry and the prism mask is planar on its side of light exit.

In the Figure, the vertically hatched area exemplifies the distribution of the bundle of rays B2 from the central opening 21 of the shutter 2, through the lenticule L and the coplanar element P1 of the prism mask PM up to the viewing plane 9. The base points B, B′ of the trapezoid characterise the corresponding luminance distribution V12 in the visibility region 6 of the viewing plane 9. This trapezoidal distribution is composed of a rectangle of the ideal distribution of the bundle of rays and by tapered margins, which are caused by the real optical properties of the lenticule and prism mask elements.

In the Figure, hatched areas indicate the overlapped bundles of rays B1 and B3 generated by the wedge elements K1 and K2. The bundle of rays B1 passes through the wedge element K1 (the upper one in the Figure) and creates the luminance distribution V11 in the viewing plane 9. The resultant trapezoid of the luminance distribution V11 is characterised in the Figure by its base points A, A′. Analogously, the base points C, C′ identify the trapezoid of the luminance distribution V13 originating from the (bottom) wedge element K2.

In the viewing plane 9, the overlapped luminance distributions V11 to V13 are perceived as the resultant luminance distribution V, indicated by a dotted line. The thus achieved multiplication of projections, which corresponds according to this invention to the number of prism mask elements (in this example K1+K2+P1=3), and the lateral overlapping of these displaced projections creates a broadened, homogeneous resultant luminance area V. As can be seen in the Figure, the broadened resultant luminance area V with its tapered margins stretches between the base points A and C′.

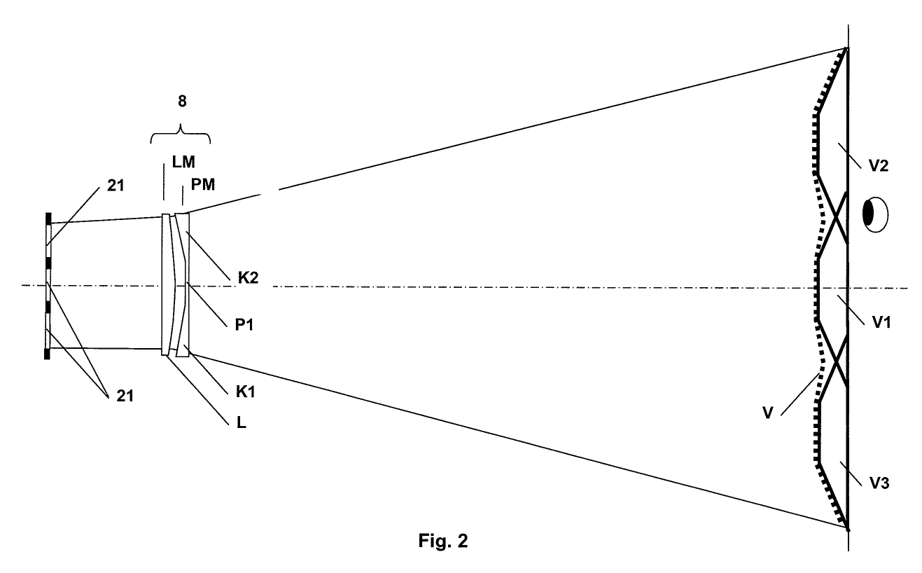

FIG. 2 shows schematically a device similar to that shown in FIG. 1, where the distribution of bundles of rays from three adjacent openings 21 of the shutter 2, through the lenticular array LM and prism mask PM up to the projections of the openings 21 in the preferred visibility region 6 of the viewing pane 9 is indicated. These three openings 21 are assigned to the same lenticule L.

In the visibility region 6 the projections of the three openings 21 create the distributions V1 to V3 corresponding to these openings of the broadened, resultant luminance areas V11 to V13 as previously explained with the help of FIG. 1. The combination of lenticular array LM and prism mask PM and the arrangement and alignment of the prism mask elements K1, K2, P1 causes the overlapped tapered margins of the luminance areas V1 to V3. The passage of the bundles of rays through the lenticule and the corresponding prism mask elements K1, K2, P1 is directed such that the tapered margins of the projections V1 to V3 of the three openings 21 overlap. In the figure, the dotted line indicates the homogeneous total luminance distribution V resulting from the overlapped distributions V1 to V3. The resultant luminance distribution V only shows an insignificant reduction in luminance in the areas where the margins overlap. The resultant luminance distribution V is thus near-homogeneous in the entire preferred visibility region 6, as stipulated as the object of the invention. A near-homogeneous illumination is achieved on the display and in the visibility region. The darker regions between the projections of the openings are almost completely eliminated, so that the image quality as perceived by the viewer is considerably improved.

FIG. 3a shows a detail of a compound unit, representing a preferred form of the combination of the lenticular array LM and prism mask PM. The Figure shows a single lenticule L and the corresponding prism mask elements K1, K2, P1 of the lenticule-prism-unit. The direction of light propagation is indicated in this Figure and the following Figures by an arrow. Here, the number of prism mask elements K1, K2, P1 and their arrangement is as explained above with the help of FIGS. 1 and 2. Two wedge elements K1, K2 also face the lenticules L, and the lenticular array LM has its plane face on the side of light entry, and the prism mask PM has its plane face on the side of light exit. The lenticule and the prism mask PM are glued together at the attachment points of lenticules and wedge elements K1, K2 so to form a compound unit. This compound unit exhibits great form stability. Its good manageability allows efficient and reliable manufacture and assembly in mass-production.

FIG. 3b shows an arrangement derived from that shown in FIG. 3a, representing another form of the lenticule-prism-unit. Here, the prism mask PM is disposed in front the lenticular array LM, seen in the direction of light propagation. This preferred embodiment minimises spherical aberrations and exhibits a higher quality of the optical projection.

FIG. 4 illustrates the approximation of an asymmetric lenticule through another combination of lenticule L and the prism mask elements. Here, a lenticule L is assigned with three wedge elements K1, K2, K3 and a coplanar element P1. As shown in the Figure, the wedge elements K1 to K3 are of different size and angular design, to achieve the desired approximation. It is even possible to do without a coplanar element, so that the prism mask is only composed of different wedge elements.

1. Lenticule-prism-unit, in particular for use in autostereoscopic displays, containing a lenticular array composed of a multitude of lenticules in the form of cylindrical lenses and a prism mask (PM) composed of prism mask elements which are aligned with the lenticules (L) of the lenticular array, characterised in that several prism mask elements are assigned to each lenticule (L), whereby this combination of lenticule and assigned prism mask elements discretely approximates an aspherical and/or asymmetric lenticule.

2. Lenticule-prism-unit, wherein the prism mask elements are wedge elements (K1, K2, . . . ) and coplanar elements (P1, P2, . . . ).

3. Lenticule-prism-unit according to claim 1, wherein the prism mask (PM) features a central coplanar element (P1) which is aligned with the optical axis of the corresponding lenticule (L).

4. Lenticule-prism-unit according to claim 1, wherein the prism mask elements (K1, K2, . . . , P1, P2, . . . ) are arranged symmetrically around the optical axis of the corresponding lenticule (L).

5. Lenticule-prism-unit according to claim 1, wherein the lenticular array (LM) and the prism mask (PM) are in contact at one or several attachment points on the curvature of the lenticules (L).

6. Lenticule-prism-unit according to claim 1, wherein the lenticular array (LM) and the prism mask (PM) form a compound unit.

7. Illumination device for an autostereoscopic display with a lenticule-prism-unit according to claim 1, which contains (seen in the direction of light propagation) an illumination matrix (7) composed of a multitude of illumination elements (21) arranged in a regular pattern and a lenticule-prism-unit (8), whereby the light of the illumination elements (21) is focused by the lenticule-prism-unit (8) so that a subsequent transmissive image matrix (5) and a selectable preferred visibility region (6) in the viewing plane (9) are illuminated in a directed manner, characterised in that the prism mask elements (K1, K2, . . . , P1, P2, . . . ) are arranged and aligned so that a near-homogeneous luminance distribution is achieved in the visibility region (6).

8. Illumination device according to claim 7, wherein the prism mask elements assigned to one lenticule generate a multitude of projections, corresponding to the number of prism mask elements, in the visibility region, said projections having luminance distributions (V11 for A, A′ to V13 for C, C′), and said prism mask elements being arranged such that the laterally displaced projections overlap, thus generating a resultant luminance distribution (V) in the broadened area (A to C′).

9. Illumination device according to claim 7, wherein the prism mask elements (K1, K2, . . . , P1, P2, . . . ) are arranged and aligned such that the projections of laterally adjacent illumination elements (21) assigned to the same lenticule (L) overlap at the tapered margins of these broadened luminance distributions (Vx), thus generating a near-homogeneous luminance distribution (V) in the visibility region (6).

10. Illumination device according to one or several of claims 7 to 9, wherein the arrangement and alignment of lenticules (L) and prism mask elements (K1, K2, . . . P1, P2, . . . ) is determined by the given overlapping areas of the luminance distribution (V) and a given geometry of illumination elements (21).

11. Illumination device according to one or more of claims 7 to 10, wherein a combination of several lenticular arrays (LM) and several prism masks (PM) is employed.
